(19) United States
(12) Patent Application Publication
(10) Pub. No.: US 2009/0133523 A1
(43) Pub. Date: May 28, 2009

(54) Error-compensating bearing screw conveying device

(76) Inventor: Cheun Bok Song, Gimpo-si (KR)

Correspondence Address: STAAS & HALSEY LLP, SUITE 700, 1201 NEW YORK AVENUE, N.W., WASHINGTON, DC, 20005, US

(21) Appl. No.: 12/230,446

(22) Filed: Aug. 28, 2008

(30) Foreign Application Priority Data
Nov. 26, 2007 (KR) 10-2007-0120768

(51) Int. Cl. F16H 25/22

(52) U.S. Cl. 74/424.82

(57) ABSTRACT

The present invention relates to an error-compensating bearing screw conveying device including: a screw shaft having a screw mounted along the outer circumferential surface thereof; a nut body adapted to fittedly insert the screw shaft thereinto along the inner circumferential surface thereof and having a plurality of mounting holes formed along the outer circumferential surface thereof in such a manner as to conform to a spiral passageway formed on the screw of the screw shaft; and a plurality of radial bearings mounted in the mounting holes of the nut body and adapted to be rotated at the fixed positions thereof in such a manner as to come into contact with the outer circumferential surface of the screw of the screw shaft along the outer races thereof when the screw shaft or the nut body is rotated; and position-adjusting means mounted on the top sides of the radial bearings so as to adjust the positions of the radial bearings in such a manner as to be oriented toward the center of the screw shaft.

### BACKGROUND OF THE INVENTION

1. Field of the Invention

The present invention relates to a screw conveying device using radial bearings, and more particularly, to an error-compensating bearing screw conveying device that has a plurality of radial bearings adapted to be rotated at a fixed position so as to serve as female screws formed along the inner peripheral surface of a nut, so that a screw shaft and the nut can be rotated by coupling the screw shaft and the nut so as to linearly move the nut or a moving block coupled to the nut, and when a predetermined gap is formed between the radial bearings and the screw on the screw shaft, the gap can be easily compensated after the formation of the gap.

2. Description of the Related Art

Generally, a ball screw conveying device has been widely used as screw conveying devices that rotate a screw shaft by coupling the screw shaft and a nut so as to linearly move the nut or a moving block coupled to the nut. The ball screw conveying device has spiral inner grooves formed along the inner circumferential surface of the nut, spiral outer grooves formed along the outer circumferential surface of the screw shaft, and a plurality of steel balls inserted between the spiral inner grooves and the spiral outer grooves, such that the friction between the screw shaft and the nut is reduced to convert the rotary movement of the screw shaft into the linear movement of the nut. FIG. 1 is a vertical sectional view showing a conventional deflector type screw conveying device using balls, which is provided with a return piece 18 so that balls 10 circulate, and FIG. 2 is a horizontal sectional view showing the ball screw conveying device of FIG. 1. As shown in FIGS. 1 and 2, a nut 13 is disposed along the outer periphery of a screw shaft 11, having spiral inner grooves 14 formed along the inner circumferential surface thereof so as to face spiral outer grooves 12 of the screw shaft 11. A plurality of steel balls 10 are inserted between the outer grooves 12 and the inner grooves 14, which are arranged to face each other and have a semi-circular cross-section. A return piece 18 is formed at one side at the interior of the nut 13 so as to circulate the balls 10. A reference numeral 17 is a portion where the balls 10 are circulated. Thus, the ball screw conveying device is constructed such that when an external rotating force is transmitted to the screw shaft 11 to rotate the screw shaft 11, the balls 10 inside the nut 13 roll along the outer grooves 12 and the inner grooves 14, thereby pushing the nut 13 or a moving block coupled thereto in the axial direction of the screw shaft 11 and circulating the balls 10 through the return piece 18 again.

However, the conventional ball screw conveying device has some problems in that it is complicated in structure, thereby making it difficult to machine it, and when machining errors or abrasion is caused between the balls 10, the balls 10 and the outer grooves 12 of the screw shaft 11, and the balls 10 and the nut 13 to form a predetermined gap between them, the collision of the parts against each other occurs to cause vibrations and noises therefrom. The vibrations and noises may cause the parts to be damaged such that the ball screw conveying device or the parts in the linear movement machines using the ball screw conveying device should be frequently repaired or replaced with new one.

### SUMMARY OF THE INVENTION

Accordingly, the present invention has been made in view of the above-mentioned problems occurring in the prior art, and it is an object of the present invention to provide an error-compensating bearing screw conveying device that is made in a simple structure, minimizes the friction between a screw shaft and a nut, and fundamentally prevents the collision between the parts in the device during a linear movement, thereby greatly reducing the vibrations, noises and the damage of the parts in the device.

It is another object of the present invention to provide an error-compensating bearing screw conveying device that easily compensates a predetermined gap after the formation of the gap even when the machining precision for the parts of the device is low to form the gap between the parts, thereby removing the noises, vibrations, heat, and back-lash caused by the collision between the parts.

It is still another object of the present invention to provide an error-compensating bearing screw conveying device that easily compensates the gap and contacting force (pre-pressure) between radial bearings and a screw, when noises, vibrations, heat, and back-lash are generated by the abrasion caused by the friction between the radial bearings and the screw, thereby removing the noises, vibrations, heat, and back-lash.

It is yet another object of the present invention to provide an error-compensating bearing screw conveying device that converts the rotary force of a screw shaft into a linear movement of a nut, in a precise manner, without any loss.

To accomplish the above objects, according to the present invention, there is provided an error-compensating bearing screw conveying device including: a screw shaft having a screw mounted along the outer circumferential surface thereof; a nut body adapted to fittedly insert the screw shaft thereinto along the inner circumferential surface thereof and having a plurality of mounting holes formed along the outer circumferential surface thereof in such a manner as to conform to a spiral passageway formed on the screw of the screw shaft; and a plurality of radial bearings mounted in the mounting holes of the nut body and adapted to be rotated at the fixed positions thereof in such a manner as to come into contact with the outer circumferential surface of the screw of the screw shaft along the outer races thereof when the screw shaft or the nut body is rotated; and position-adjusting means mounted on the top sides of the radial bearings so as to adjust the positions of the radial bearings in such a manner as to be oriented toward the center of the screw shaft.

According to the present invention, preferably, the position-adjusting means includes: a support projection formed along the lower end periphery of each mounting hole of the nut body; a spring adapted to be inserted into each mounting hole and mounted along the top periphery of the support projection; a holder adapted to be inserted into each mounting hole and mounted along the top periphery of the spring in such a manner as to fix a rotary shaft of each radial bearing on the lower portion thereof; and a compensating cap screw-coupled to the top end periphery of each mounting hole so as to pressurize the holder toward the spring and adapted to adjust the height of the holder in the center direction of the screw shaft according to the degree of fastening thereof.

According to the present invention, the position-adjusting means includes: a support projection formed along the lower end periphery of each mounting hole of the nut body; a spring adapted to be inserted into each mounting hole and mounted on the top periphery of the support projection; a holder adapted to be inserted into each mounting hole and mounted along the top periphery of the spring and having a pin channel formed on the top surface thereof in such a manner as to insert a bar-like compensating pin thereinto and to fix a rotary shaft of each radial bearing on the lower portion thereof; a pin hole formed on the nut body so as to pass through each mounting hole in a lengthwise direction of the screw shaft; and the compensating pin adapted to be inserted into the pin hole of the nut body and the pin channel of the holder so as to adjust the height of the holder in the center direction of the screw shaft by means of the diameter of the portion thereof inserted into the pin channel.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a vertical sectional view showing a conventional screw conveying device using balls;

FIG. 2 is a sectional view taken along the line A-A of FIG. 1;

FIG. 3 is an exploded perspective view showing an error-compensating bearing screw conveying device according to a first embodiment of the present invention;

FIG. 4 is a vertical sectional view showing the error-compensating bearing screw conveying device according to the first embodiment of the present invention;

FIG. 5 is a horizontal sectional view showing the error-compensating bearing screw conveying device according to the first embodiment of the present invention;

FIG. 6 is a perspective view showing a holder adopted in the first embodiment of the present invention;

FIG. 7 is a partly sectional view showing the relation between a compensating cap, a holder, a radial bearing and a screw in the first embodiment of the present invention;

FIG. 8 is a vertical sectional view showing the conveying operation of the error-compensating bearing screw conveying device according to the first embodiment of the present invention;

FIG. 9 is a partly sectional view showing the-relation between a compensating cap, a holder, a radial bearing and a screw in the first embodiment of the present invention when the screw has a generally triangular sectional shape;

FIG. 10 is an exploded perspective view showing an error-compensating bearing screw conveying device according to a second embodiment of the present invention;

FIG. 11 is a vertical sectional view showing the error-compensating bearing screw conveying device according to the second embodiment of the present invention;

FIG. 12 is a horizontal sectional view showing the error-compensating bearing screw conveying device according to the second embodiment of the present invention;

FIG. 13 is a perspective view showing a holder adopted in the second embodiment of the present invention;

FIG. 14 is a partly sectional view showing the relation between a compensating pin, a holder, a radial bearing and a screw in the second embodiment of the present invention;

FIG. 15 is a partly sectional view showing the relation between the diameter of the compensating pin and the position of the holder in the second embodiment of the present invention;

FIG. 16 is a vertical sectional view showing the conveying operation of the error-compensating bearing screw conveying device according to the second embodiment of the present invention;

FIG. 17 is a vertical sectional view showing the mounting state of a compensating pin on the radial bearing in the error-compensating bearing screw conveying device according to the second embodiment of the present invention;

FIGS. 18a and 18b are partly sectional views showing the method for contacting the radial bearing with the screw in the second embodiment of the present invention when the screw has a generally trapezoidal sectional shape; and

FIGS. 19 and 20 are vertical sectional views showing the error-compensating bearing screw conveying device with oil-storing tanks mounted thereon in the second embodiment of the present invention.

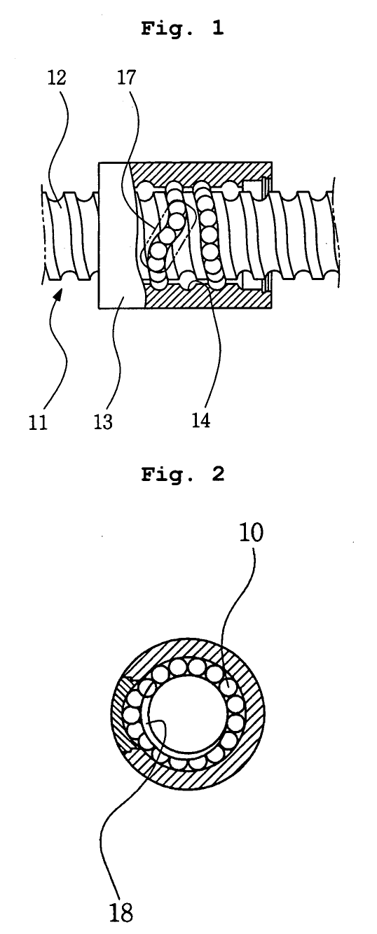

### DETAILED DESCRIPTION OF THE PREFERRED EMBODIMENTS

Hereinafter, an explanation on an error-compensating bearing screw conveying device according to preferred embodiments of the present invention will be given with reference to the attached drawings.

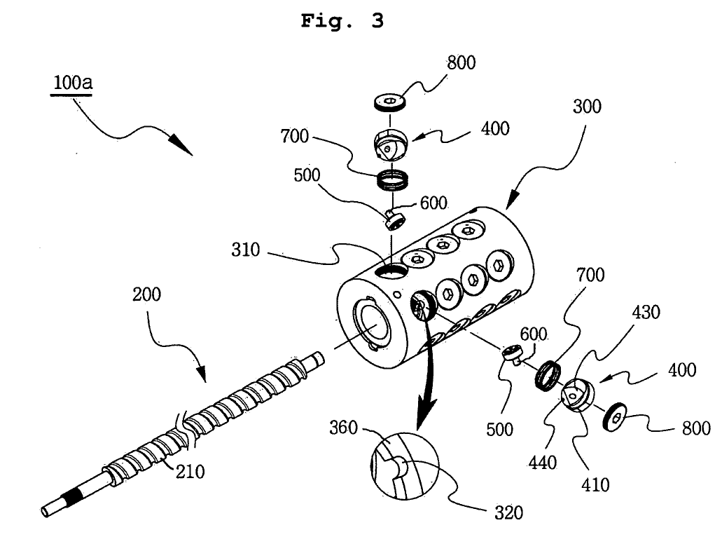

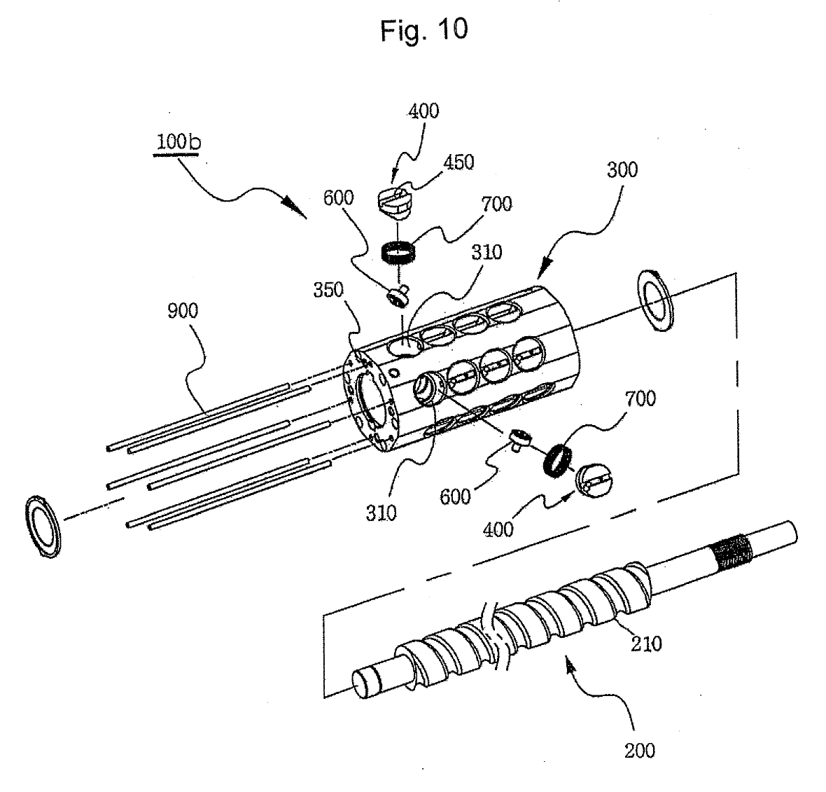

FIGS. 3 to 9 show an error-compensating bearing screw conveying device according to a first embodiment of the present invention, and FIGS. 10 to 20 show an error-compensating bearing screw conveying device according to a second embodiment of the present invention. The first embodiment of the present invention has a compensating cap 800 as position-adjusting means for radial bearings, and the second embodiment of the present invention has a compensating pin 900 as position-adjusting means for radial bearings.

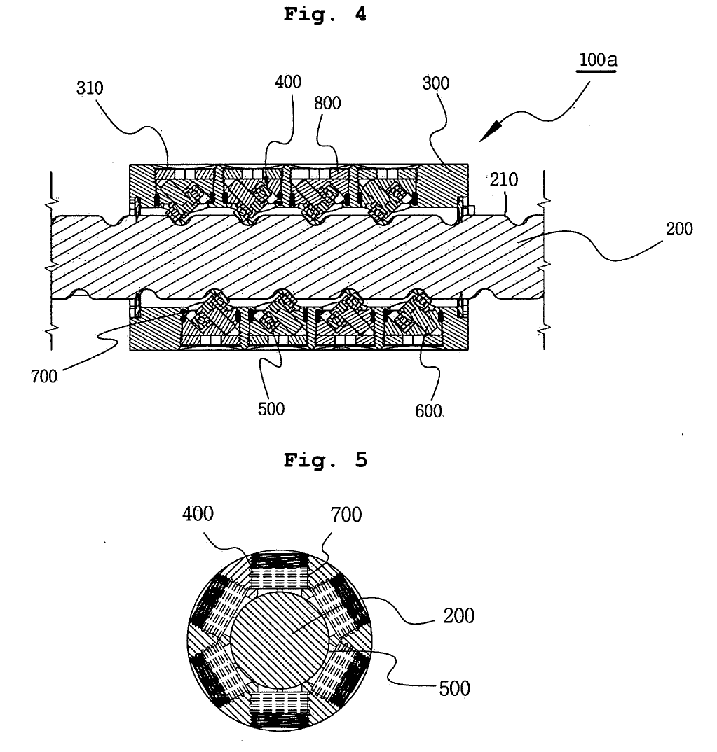

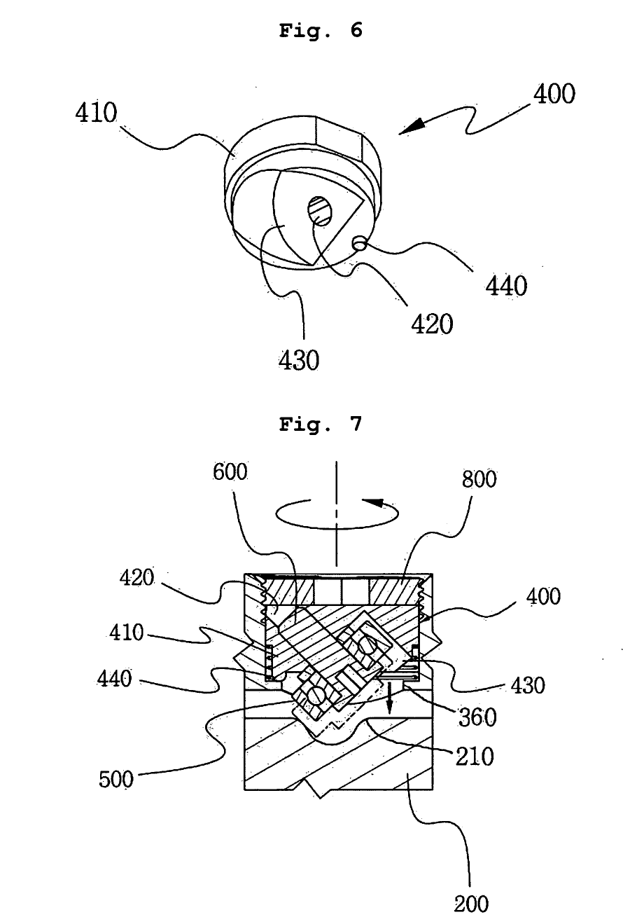

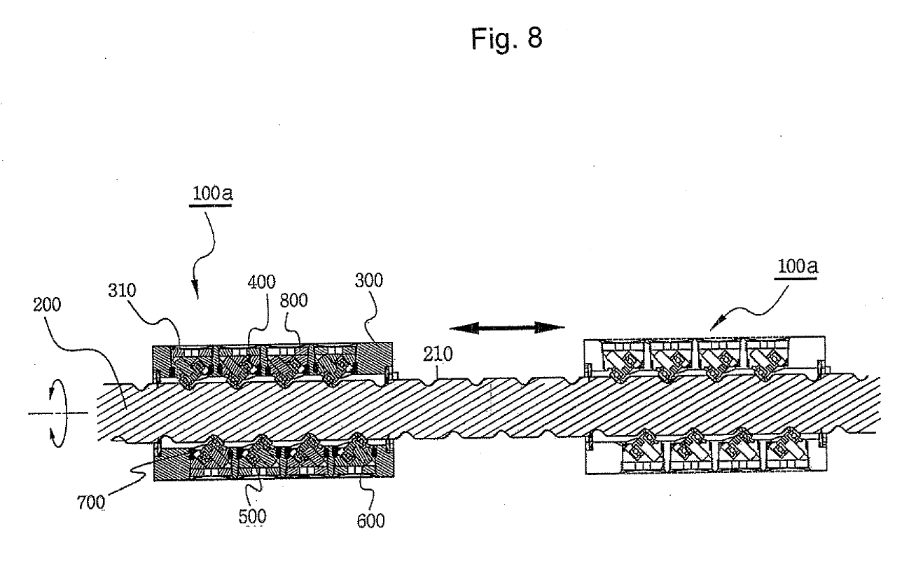

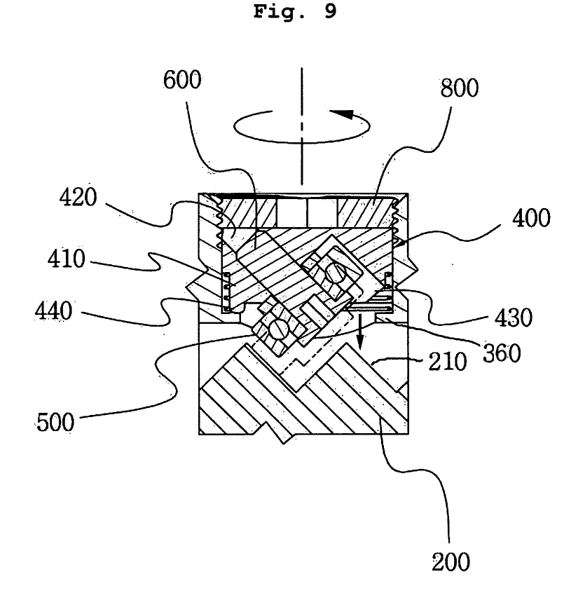

FIG. 3 is an exploded perspective view showing an error-compensating bearing screw conveying device according to a first embodiment of the present invention, FIG. 4 is a vertical sectional view showing the error-compensating bearing screw conveying device according to the first embodiment of the present invention, FIG. 5 is a horizontal sectional view showing the error-compensating bearing screw conveying device according to the first embodiment of the present invention, FIG. 6 is a perspective view showing a holder adopted in the first embodiment of the present invention, FIG. 7 is a partly sectional view showing the relation between a compensating cap, a holder, a radial bearing and a screw in the first embodiment of the present invention, FIG. 8 is a vertical sectional view showing the conveying operation of the error-compensating bearing screw conveying device according to the first embodiment of the present invention, and FIG. 9 is a partly sectional view showing the relation between a compensating cap, a holder, a radial bearing and a screw in the first embodiment of the present invention when the screw has a generally triangular sectional shape.

Referring to FIGS. 3 to 5, there is provided an error-compensating bearing screw conveying device according to the first embodiment of the present invention including a screw shaft 200 having a screw 210 mounted along the outer circumferential surface thereof and a cylindrical nut body 300 adapted to fittedly insert the screw shaft 200 thereinto along the inner circumferential surface thereof. Rotary power like a motor is connected to the screw shaft 200, and a moving block is connected to the nut body 300. If necessary, the screw shaft 200 is fixed, and all of the rotary power and the moving block are connected to the nut body 300. Especially, if the screw shaft 200 is relatively long, the nut body 300 is rotated and at the same time the fixed screw shaft 200 is linearly moved, which is more effective when compared with that the screw shaft 200 is rotated by external power to linearly move the nut body 300. In the preferred embodiments of the present invention, the screw shaft 200 is rotated by external power to linearly move the nut body 300, but the present invention is not limited only thereto. Of course, it is possible that the nut body 300 is rotated by external power and at the same time the fixed screw shaft 200 is linearly moved.

According to one of the features of the error-compensating bearing screw conveying device according to the present invention, the nut body 300 has a plurality of mounting holes 310 formed along the outer circumferential surface thereof in such a manner as to conform to a spiral passageway formed on the screw 201 of the screw shaft 200 and a plurality of radial bearings 500 mounted in the mounting holes 310 of the nut body 300 by means of the connection of a rotary shaft 600. As shown in FIG. 4, at this time, each of the plurality of radial bearings 500 comes into contact with the edge portion or later surface of each of the screw threads of the screw 201 along the outer races thereof. As a result, the female screws of the nut are formed in such a manner as to face the male screws of the screw shaft 200. At this time, in order to move the nut body 300 in clockwise and counter-clockwise directions by the two-way rotation of the screw shaft 200, the half of the plurality of radial bearings 500 is adapted to come into contact with the screw 201 only when the screw shaft 200 is rotated in the clockwise direction, and the rest thereof is adapted to come into contact with the screw 201 only when the screw shaft 200 is rotated in the counter-clockwise direction. Therefore, even when the screw shaft 200 is rotated to any direction of the clockwise and counter-clockwise directions, or even when the nut body 300 is moved in any direction, the radial bearings 500 are just rotated in the state of being brought into contact with the edge portions or lateral surfaces of the screw threads of the screw 201 along the outer races thereof, at fixed positions without any displacement.

Under the above-mentioned simple structure, the screw conveying device according to the present invention minimizes the friction range between the screw shaft 200 and the nut body 300 and basically prevents the friction-reduced parts (e.g., radial bearings) in this device from colliding against each other during the linear movement, thereby reducing the vibrations, noises and the damage on the radial bearings.

According to another features of the error-compensating bearing screw conveying device according to the present invention, the positions of the radial bearings 500 with respect to the screw shaft 200 are adjusted when the radial bearings 500 are mounted in the mounting holes 310 of the nut body 300 by means of the connection of the rotary shaft 600 thereto. Thus, the error-compensating bearing screw conveying device according to the present invention includes position-adjusting means. If the machining precision of the screw 201, the nut body 300, the mounting holes 310, the rotary shafts 600, and the radial bearings 500 is low, after the assembling for the parts, a predetermined gap is formed between the radial bearings 500 and the screw 201 on the screw shaft 200 such that the radial bearings 500 do not come into contact with the screw 201 by means of an appropriate pre-pressure. At this time, the position-adjusting means serves to compensate the gap, and further, when the noises, vibrations, heat, and back-lash are generated by the collision and friction between the parts, the position-adjusting means serves to adjust and compensate the gap and pre-pressure between the radial bearings 500 and the screw 201.

Referring to FIGS. 3, 6 and 7, according to the first embodiment of the present invention, the position-adjusting means includes: a support projection 360 formed along the lower end periphery of each mounting hole 310 of the nut body 300; a spring 700 adapted to be inserted into each mounting hole 310 and mounted along the top periphery of the support projection 360; a holder 400 adapted to be inserted into each mounting hole 310 and mounted along the top periphery of the spring 700 in such a manner as to fix the rotary shaft 600 of each radial bearing 500 on the lower portion thereof; and a compensating cap 800 screw-coupled to the top end periphery of each mounting hole 310 so as to pressurize the holder 400 toward the spring 700 and adapted to adjust the height of the holder 400 in the center direction of the screw shaft 200 according to the degree of fastening thereof.

The holder 400 has such a shape and size movable upwardly and downwardly in each mounting hole 310. Thus, if the mounting hole 310 is of a cylindrical shape, the holder 400 has a cylindrical shape having a diameter insertedly movable into the mounting hole 310. Also, a body 410 of the holder 400 preferably has the outer diameter of the lower periphery thereof smaller than that of the upper periphery thereof, thereby being stepped between the upper and lower peripheries thereof. The spring 700 is insertedly fitted along the lower periphery of the body 410 having the smaller outer diameter than the upper periphery thereof and is locked to the stepped portion of the body 410.

The holder 400 has a shaft hole 420 formed on the lower portion thereof so as to fix the rotary shaft 600 of each radial bearing 500 thereto. The shaft hole 420 forms a tap therein, and the rotary shaft 600 forms a screw on the portion inserted into the shaft hole 410 so as to be coupled to the tap of the shaft hole 410, thereby screw-coupling the rotary shaft 600 to the shaft hole 410.

The holder 400 has a bearing seat 430 formed on the lower portion thereof so as to slantedly insert a portion of the radial bearing 500 thereon, such that a portion of the radial bearing 500 is insertedly mounted on the bearing seat 430 and the rest thereof is protruded outwardly from the bearing seat 430 in such a manner as to come into contact with the screw 210 along the outer race thereof. At this time, the inclined angle of the bearing seat 430 is varied depending upon the structure of the screw 210 of the screw shaft 200, but the inclined angle of the bearing seat 430 is set to allow the outer race of the radial bearing 500 to come into contact with the edge portion or lateral surface of the screw thread of the screw 210. Further, the shaft hole 420 is formed on the bottom surface of the bearing seat 430 and has a vertical direction with respect to the bottom surface of the bearing seat 430. As a result, even though the mounting hole 310 is formed vertically with respect to the lengthwise direction of the screw shaft 200, the radial bearing 500 is inclinedly maintained, and the mounting angle of the radial bearing 500 is adjustable only with the exchange of the holder 400.

As shown in FIGS. 3 and 6, the body 410 of the holder 400 has a protrusion 440 formed integrally with the lower portion thereof, and the mounting hole 310 has a stopper groove 320 formed on the support projection 360 along the lower end periphery thereof so as to insert the protrusion 440 thereinto, such that the radial bearing 500 inserted into the holder 400 is always fixed to a predetermined direction.

The lower end periphery of the spring 700 abuts against the top periphery of the support projection 360, and the upper end periphery of the spring 700 is insertedly fitted to the lower end periphery of the body 410 of the holder 400.

As shown in FIG. 7, the compensating cap 800 has a male screw formed along the outer periphery thereof, and the mounting hole 310 has a female screw formed along the inner top periphery thereof in such a manner as to be coupled to the male screw of the compensating cap 800.

Through the position-adjusting means in the first embodiment of the present invention under the above-mentioned structure, as shown in FIG. 7, if the gap is formed between the screw 201 and the radial bearings 500, the compressing force is excessively large therebetween, or the pre-pressure is not appropriate, due to the machining errors of the parts and the abrasion of the parts while in use, the compensating cap 800 is turned downwardly or upwardly. As a result, the holder 400 resists or receives the repulsive force of the spring 700 at the lower side of the compensating cap 800, while being turned upwardly and downwardly. Therefore, the gap and pre-pressure formed between the screw 201 and the radial bearings 500 are easily adjusted from the outside, without having any disassembling process for the entire screw conveying device.

FIG. 8 shows the error-compensating bearing screw conveying device 100a wherein the nut body 300 is conveyed in left and right directions thereof by the rotation of the screw shaft 200, in the state where the gap and pre-pressure formed between the screw 201 and the radial bearings 500 are adjusted by means of the compensating cap 800. The radial bearings 500 serve to convert the rotation of the screw shaft 200 into the linear movement of the nut body 300 without any loss.

In the error-compensating bearing screw conveying device 100a according to the present invention, the screw 201 of the screw shaft 200 has a semi-circular groove sectional shape, as shown in FIGS. 3 to 8, and in addition thereto, the screw 201 has a triangular sectional shape, as shown in FIG. 9. Of course, the screw 201 may have a trapezoidal sectional shape or other sectional shapes. As shown in FIG. 9, if the screw 201 has a triangular sectional shape, the radial bearing 500 desirably comes into contact with the lateral surface of the screw thread of the screw 201. In this case, even though the screw shaft 200 is rotated at a high speed, the contacting degree between the screw 201 and the radial bearings 500 is good such that the noises become reduced and the supporting force to the shaft direction is improved, thereby permitting the nut body 300 to be more stably conveyed.

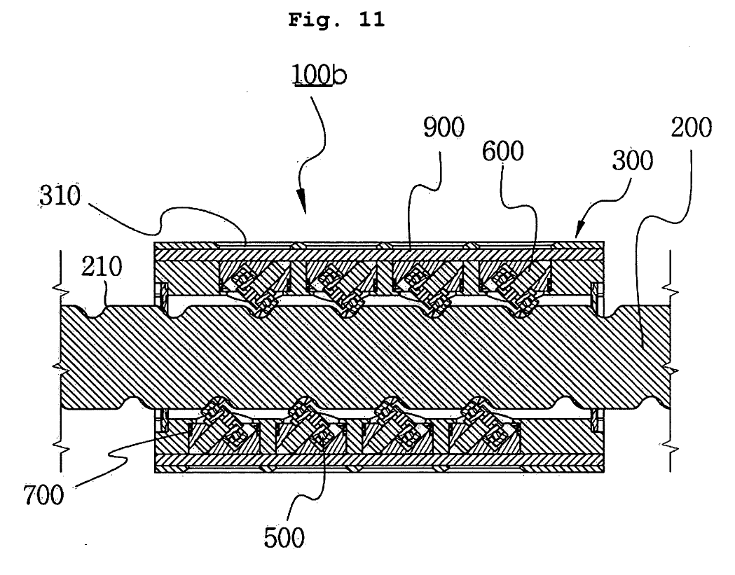

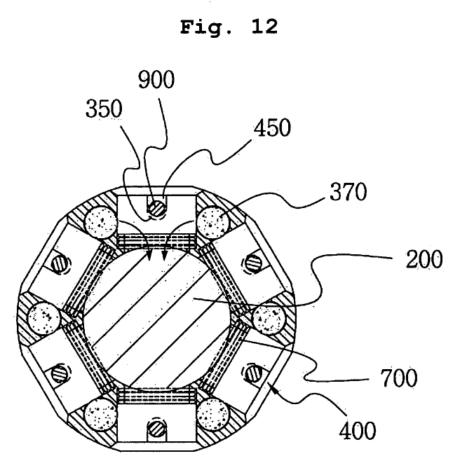

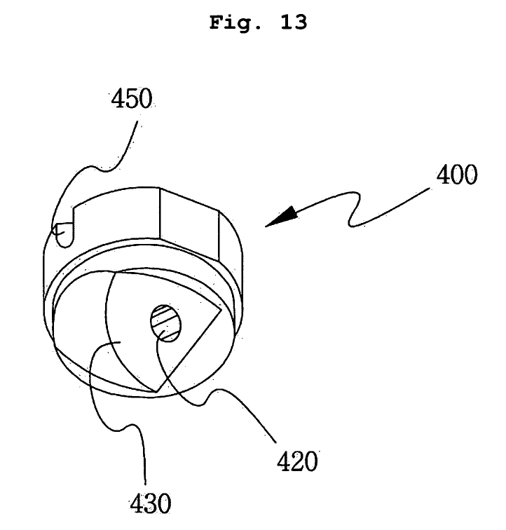

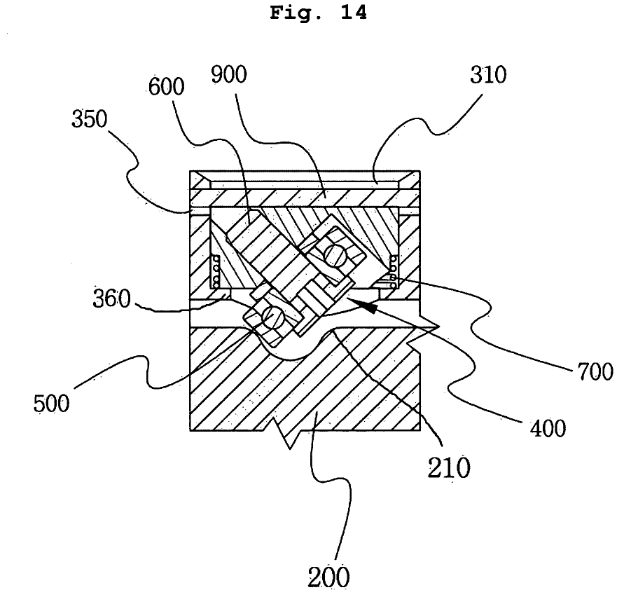

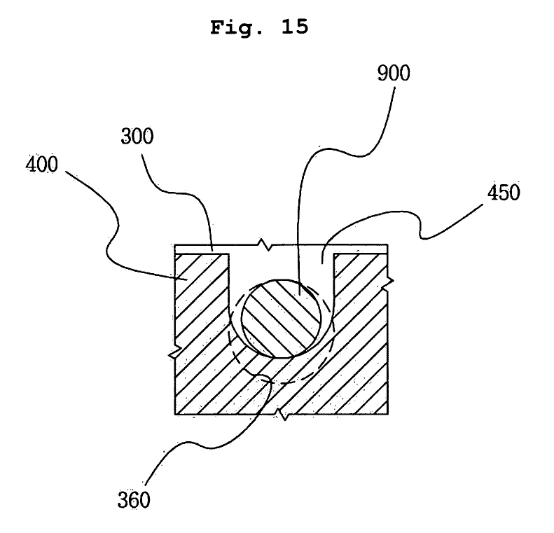

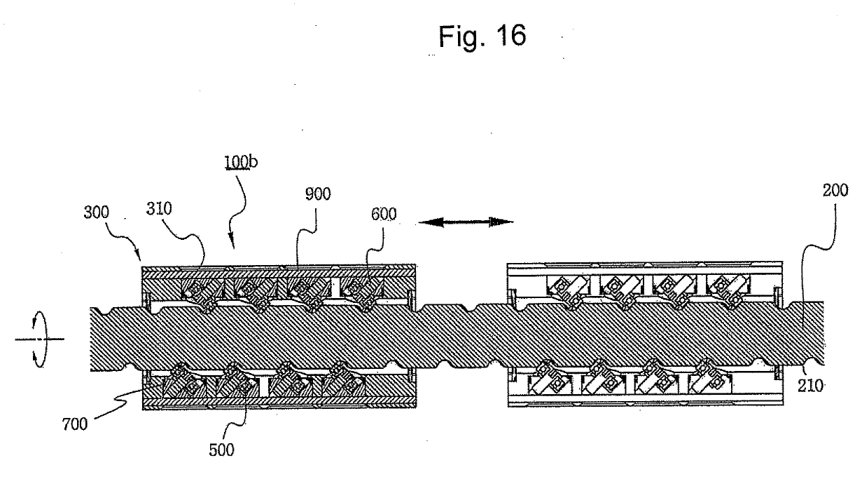

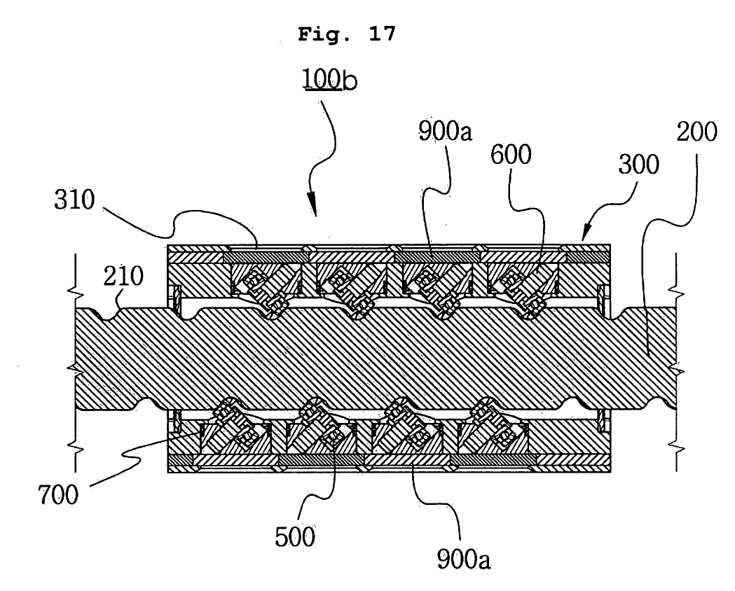

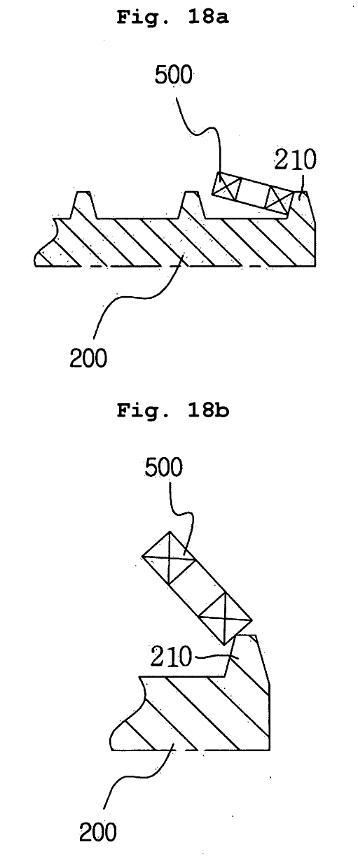

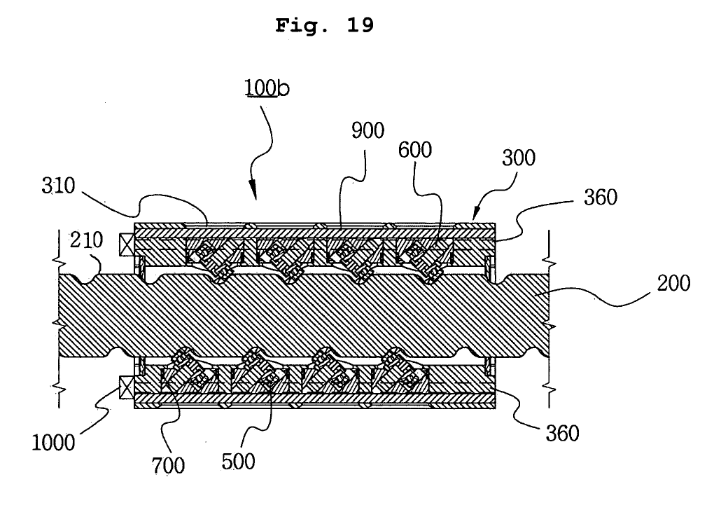

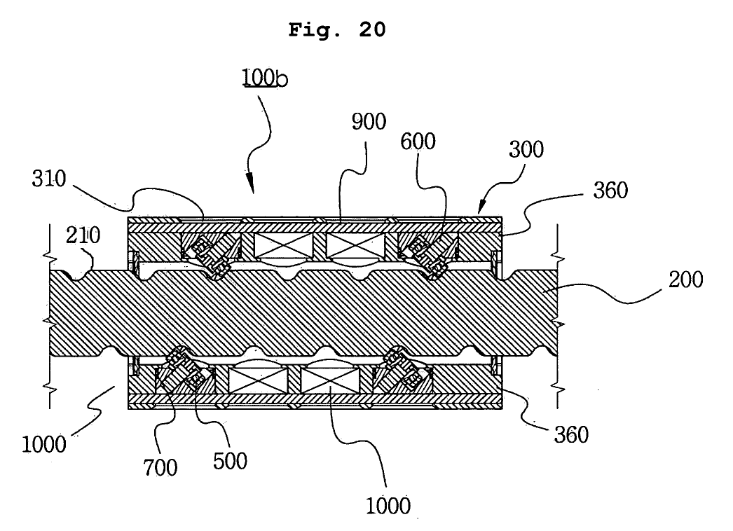

FIG. 10 is an exploded perspective view showing an error-compensating bearing screw conveying device according to a second embodiment of the present invention, FIG. 11 is a vertical sectional view showing the error-compensating bearing screw conveying device according to the second embodiment of the present invention, FIG. 12 is a horizontal sectional view showing the error-compensating bearing screw conveying device according to the second embodiment of the present invention, FIG. 13 is a perspective view showing a holder adopted in the second embodiment of the present invention, FIG. 14 is a partly sectional view showing the relation between a compensating pin, a holder, a radial bearing and a screw in the second embodiment of the present invention, FIG. 15 is a partly sectional view showing the relation between the diameter of the compensating pin and the position of the holder in the second embodiment of the present invention, FIG. 16 is a vertical sectional view showing the conveying operation of the error-compensating bearing screw conveying device according to the second embodiment of the present invention, FIG. 17 is a vertical sectional view showing the mounting state of a compensating pin on the radial bearing in the error-compensating bearing screw conveying device according to the second embodiment of the present invention, FIGS. 18a and 18b are partly sectional views showing the method for contacting the radial bearing with the screw in the second embodiment of the present invention when the screw has a generally trapezoidal sectional shape, and FIGS. 19 and 20 are vertical sectional views showing the error-compensating bearing screw conveying device with oil-storing tanks mounted thereon in the second embodiment of the present invention.

As shown in FIGS. 10 and 14, according to the second embodiment of the present invention, the position-adjusting means includes: a support projection 360 formed along the lower end periphery of each mounting hole 310 of the nut body 300; a spring 700 adapted to be inserted into each mounting hole 310 and mounted along the top periphery of the support projection 360; a holder 400 adapted to be inserted into each mounting hole 310 and mounted along the top periphery of the spring 700 and having a pin channel 450 formed on the top surface thereof in such a manner as to insert a bar-like compensating pin 900 thereinto and to fix a rotary shaft 600 of each radial bearing 500 on the lower portion thereof; a pin hole 350 formed on the nut body 300 so as to pass through each mounting hole 310 in a lengthwise direction of the screw shaft 200; and the compensating pin 900 adapted to be inserted into the pin hole 350 of the nut body 300 and the pin channel 450 of the holder 400 so as to adjust the height of the holder 400 in the center direction of the screw shaft 200 by means of the diameter of the portion thereof inserted into the pin channel 450.

The compensating pin 900 is inserted into the pin hole 350 formed on the lateral surface of the nut body 300 and into the pin channel 450 formed on the top surface of the holder 400, in the state where the spring 700 and the holder 400 coupled to the radial bearing 500 are inserted into the mounting hole 310. As shown in FIGS. 10 to 12, if the compensating quantities of the plurality of radial bearing 500 are the same as each other, only a single compensating pin 900 having a substantially long length can pressurize all of the holders 400 mounted into the plurality of mounting holes 310 in the lengthwise direction of the screw shaft 200. However, as shown in FIG. 17, if the compensating quantities of the plurality of radial bearing 500 are different from each other by the different machining errors or abrasion degrees, the compensating pins 900a are cut to a little longer length than the pin channel 450 of the holder 400 so as to have different diameters from each other. Thus, the plurality of compensating pins 900a are mounted individually on each holder 400, and an auxiliary pin is filled into the gap formed between the compensating pins 900a.

Referring to FIGS. 10 and 13, the position-adjusting means according to the second embodiment of the present invention is different from that according to the first embodiment of the present invention in that the compensating pin 900 instead of the compensating cap 800 is adopted as the error-compensating means, the pin channel 450 is formed on the top surface of the holder 400, and the pin hole 350 is formed on the nut body 300.

Even though not shown in the drawings, the length of the compensating pin 900 or the entire length of the compensating pin 900a and the auxiliary pin is formed shorter than the length of the nut body 300, such that since the pin hole 350 is not filled at the both sides of the nut body 300, a screw is coupled to the portion not filled with the pin hole 350, thereby fixing the compensating pin 900.

In the position-adjusting means according to the second embodiment of the present invention, the compensating quantities of the radial bearings 500 are adjusted by the size of the diameter of the compensating pin 500, thereby advantageously allowing the error to be compensated to a very minute degree. Referring to FIGS. 14 and 15, if the diameter of the compensating pin 900 is large, the holder 400 and the radial bearing 500 coupled rotatably to the holder 400 are moved downwardly, and contrarily, if the diameter of the compensating pin 900 is small, the holder 400 and the radial bearing 500 are moved upwardly by the elasticity of the spring 700. At this time, the support projection 360 and the spring 700 continuously provide their upward elastic supporting force to the holder 400.

In more detail, as shown in FIG. 15, if the compensating pin 900 is inserted into the pin hole 350 of the nut body 300 and the pin channel 450 of the holder 400, the holder 400 receives the elastic force from the spring 700 and springs upwardly, and therefore, the compensating pin 900 inserted into the pin channel 450 of the holder 400 is also pressurized upwardly. At this time, a portion of the compensating pin 900 is inserted and locked to the pin hole 350. Thus, if the diameter of the compensating pin 900 is large, the compensating pin 900 more pressurizes the holder 400 downwardly when compared with that having a relatively small diameter, such that the radial bearing 500 is moved toward the center of the screw shaft 200. This compensates the abrasion quantity caused by the machining errors or friction such that the screw 200 and the radial bearings 500 come into contact with each other with an appropriate pre-pressure.

Therefore, while the radial bearings 500 are rolled in the state of being brought into contact with the screw 200, noises are greatly reduced and more precise conveying distance is obtained when compared with existing ball screws, and further, when the pre-pressure is decreased by the abrasion of the radial bearings 500, the error compensation is conducted without having any disassembling process for the entire screw conveying device.

FIG. 16 shows the error-compensating bearing screw conveying device 100b wherein the nut body 300 is conveyed in left and right directions thereof by the rotation of the screw shaft 200, in the state where the gap and pre-pressure formed between the screw 201 and the radial bearings 500 are adjusted by means of the compensating pin 900. The radial bearings 500 serve to convert the rotation of the screw shaft 200 into the linear movement of the nut body 300 without any loss.

On the other hand, if the radial bearings 500 are rolled in the state of coming into contact with the screw 200 for a long term to cause the abrasion thereon, the pre-pressure caused by the contact of the radial bearings 500 with the screw 200 is low to form a gap therebetween. Thus, the collision, noises, vibrations, heat, and back-lash are generated from the parts. In this case, the compensating pin 900 having a larger diameter than the previously mounted compensating pin 900 is inserted into the pin hole 350 of the nut body 300, and the previously mounted compensating pin 900 having a relatively small diameter is removed from the pin hole 350 of the nut body 300 and the pin channel 450 of the holder 400. Thus, when the compensating pin 900 having a relatively large diameter is inserted into the pin hole 350 of the nut body 300 and the pin channel 450 of the holder 400, the compensating pin 900 more pressurizes the holder 400 by its increased diameter, thereby adjusting the gap and pre-pressure between the radial bearings 500 and the screw shaft 200 and removing the collision, noises, vibrations, heat, and back-lash from the parts.

In the error-compensating bearing screw conveying device 100b according to the second embodiment of the present invention, the screw 201 of the screw shaft 200 has a semi-circular groove sectional shape, as shown in FIGS. 10 to 17, and in addition thereto, the screw 201 has a trapezoidal sectional shape, as shown in FIGS. 18a and 18b. Of course, the screw 201 may have a triangular sectional shape or other sectional shapes. As shown in FIG. 18a, if the screw 201 has a trapezoidal sectional shape, the radial bearing 500 desirably comes into contact with the lateral surface of the screw thread of the screw 201. In this case, even though the screw shaft 200 is rotated at a high speed, the contacting degree between the screw 201 and the radial bearings 500 is good such that the noises become reduced and the supporting force to the shaft direction is improved, thereby permitting the nut body 300 to be more stably conveyed. However, if the screw shaft 200 is not rotated at a high speed, as shown in FIG. 18b, the radial bearings 500 may come into contact with the edge portions of the screw threads of the screw 201.

In the error-compensating bearing screw conveying device according to the second embodiment of the present invention, as shown in FIG. 12, the nut body 300 has a plurality of oil supply holes 370 formed to communicate with the mounting holes 310 so as to supply oil to the friction portion between the radial bearings 500 and the screw 200. Further, as shown in FIGS. 19 and 20, the nut body 300 has a plurality of oil-storing tanks 1000 mounted on the outside or inside thereof in such a manner as to communicate with the oil supply holes 370. If the oil-storing tanks 1000 are mounted on the inside of the nut body 300, as shown in FIG. 20, the radial bearings 500 are inserted into the mounting holes 310 formed at the both ends of the nut body 300, and the oil-storing tanks 1000 are inserted into the mounting holes 310 formed in the middle portion of the nut body 300. The formation of the oil supply holes 370 and the oil-storing tanks 1000 ensures excellent lubrication properties and reduced abrasion quantity.

As set forth in the foregoing, according to the preferred embodiments of the present invention, the error-compensating bearing screw conveying device is made in a simple structure, minimizes the friction between a screw shaft and a nut, and fundamentally prevents the collision between the parts in the device during a linear movement, thereby greatly reducing the vibrations, noises and the damage of the parts in the device.

Additionally, the error-compensating bearing screw conveying device easily compensates a predetermined gap after the formation of the gap even when the machining precision for the parts of the device is low to form the gap between the parts, thereby removing the noises, vibrations, heat, and back-lash caused by the collision between the parts and making the life term of the device to be substantially extended. Moreover, the error-compensating bearing screw conveying device converts the rotary force of a screw shaft into a linear movement of a nut, in a precise manner, without any loss, thereby achieving high degrees of energy efficiency and conveying precision.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An error-compensating bearing screw conveying device comprising:
a screw shaft having a screw mounted along the outer circumferential surface thereof;
a nut body adapted to fittedly insert the screw shaft thereinto along the inner circumferential surface thereof and having a plurality of mounting holes formed along the outer circumferential surface thereof in such a manner as to conform to a spiral passageway formed on the screw of the screw shaft; and
a plurality of radial bearings mounted in the mounting holes of the nut body and adapted to be rotated at the fixed positions thereof in such a manner as to come into contact with the outer circumferential surface of the screw of the screw shaft along the outer races thereof when the screw shaft or the nut body is rotated; and
position-adjusting means mounted on the top sides of the radial bearings so as to adjust the positions of the radial bearings in such a manner as to be oriented toward the center of the screw shaft.

2. The error-compensating bearing screw conveying device according to claim 1, wherein the position-adjusting means comprises: a support projection formed along the lower end periphery of each mounting hole of the nut body; a spring adapted to be inserted into each mounting hole and mounted along the top periphery of the support projection; a holder adapted to be inserted into each mounting hole and mounted along the top periphery of the spring in such a manner as to fix a rotary shaft of each radial bearing on the lower portion thereof; and a compensating cap screw-coupled to the top end periphery of each mounting hole so as to pressurize the holder toward the spring and adapted to adjust the height of the holder in the center direction of the screw shaft according to the degree of fastening thereof.

3. The error-compensating bearing screw conveying device according to claim 1, wherein the position-adjusting means comprises: a support projection formed along the lower end periphery of each mounting hole of the nut body; a spring adapted to be inserted into each mounting hole and mounted along the top periphery of the support projection; a holder adapted to be inserted into each mounting hole and mounted along the top periphery of the spring and having a pin channel formed on the top surface thereof in such a manner as to insert a bar-like compensating pin thereinto and to fix a rotary shaft of each radial bearing on the lower portion thereof; a pin hole formed on the nut body so as to pass through each mounting hole in a lengthwise direction of the screw shaft; and the compensating pin adapted to be inserted into the pin hole of the nut body and the pin channel of the holder so as to adjust the height of the holder in the center direction of the screw shaft by means of the diameter of the portion thereof inserted into the pin channel.

4. The error-compensating bearing screw conveying device according to claim 1, wherein the half of the plurality of radial bearings is adapted to come into contact with the screw only when the screw shaft is rotated in a clockwise direction, and the rest thereof is adapted to come into contact with the screw only when the screw shaft is rotated in a counter-clockwise direction.

5. The error-compensating bearing screw conveying device according to claim 2, wherein the holder has a body having a protrusion formed integrally with the lower portion thereof, and the mounting hole has a stopper groove 320 formed on the support projection formed along the lower end periphery thereof so as to insert the protrusion thereinto, such that the radial bearing inserted into the holder is always fixed to a predetermined direction.

6. The error-compensating bearing screw conveying device according to claim 2, wherein the holder has a bearing seat formed on the lower portion thereof so as to slantedly insert a portion of the radial bearing thereon, such that a portion of the radial bearing is insertedly mounted on the bearing seat and the rest thereof is protruded outwardly from the bearing seat in such a manner as to come into contact with the screw along the outer race thereof.

7. The error-compensating bearing screw conveying device according to claim 3, wherein the compensating pin has such a length as pressurizing all of the holders mounted into the plurality of mounting holes in the lengthwise direction of the screw shaft.

8. The error-compensating bearing screw conveying device according to claim 3, wherein the compensating pin is longer than the width of the pin channel of the holder and is formed plurally so as to pressurize each of the radial bearings having different machining errors and abrasion degrees from each other.

9. The error-compensating bearing screw conveying device according to claim 3, wherein the holder has a body having a protrusion formed integrally with the lower portion thereof, and the mounting hole has a stopper groove 320 formed on the support projection formed along the lower end periphery thereof so as to insert the protrusion thereinto, such that the radial bearing inserted into the holder is always fixed to a predetermined direction.

10. The error-compensating bearing screw conveying device according to claim 3, wherein the holder has a bearing seat formed on the lower portion thereof so as to slantedly insert a portion of the radial bearing thereon, such that a portion of the radial bearing is insertedly mounted on the bearing seat and the rest thereof is protruded outwardly from the bearing seat in such a manner as to come into contact with the screw along the outer race thereof.
